(19) United States
(12) Patent Application Publication
(10) Pub. No.: US 2015/0047642 A1
(43) Pub. Date: Feb. 19, 2015

(54) Half Facepiece

(71) Applicant: Scott Technologies. Inc., Boca Raton, FL (US)

(72) Inventors: Carl Escort Tucker, Conwy (GB); John Slemmen, Merseyside (GB); Gareth Dyfan Evans, Wrexham (GB); Garath Tudor Roberts, Wrexham (GB); Chris Ward, Denbigshire (GB); Troy Alan Baker, Denbigshire (GB); Graham Peter Wilson, Flintshire (GB); Robert Charles Sutton, Merseyside (GB); Amy Elizabeth Quiring, Matthews, NC (US); Michael Parham, Weddington, NC (US); Nigel Holmes, Lancashire (GB)

(21) Appl. No.: 14/528,114

(22) Filed: Oct. 30, 2014

Related U.S. Application Data
(63) Continuation of application No. PCT/US13/38820, filed on Apr. 30, 2013.
(60) Provisional application No. 61/640,515, filed on Apr. 30, 2012.

(51) Int. Cl. A62B 23/02; A62B 18/02

(52) U.S. Cl. CPC A62B 23/025; A62B 18/025
USPC 128/206.17

(57) ABSTRACT

A semi-disposable face mask has a shaped molded base composed of silicone and/or TPE and molded forming a face seal, a filter media and a support structure that houses the shaped molded base and filter media in fluid communication allowing airflow from an environment through the filter media to the face seal.

### CROSS-REFERENCE TO RELATED APPLICATIONS

This application is a continuation of International Application No. PCT/US13/38820 filed Apr. 30, 2013, which claims the benefit of U.S. Provisional Patent Application No. 61/640,515 filed Apr. 30, 2012, the contents of which are incorporated herein by reference.

### FIELD OF THE INVENTION

The invention relates generally to semi-disposable face masks with improved face seal compositions and characteristics useful in protective equipment for emergency personnel or industrial work.

### SUMMARY OF THE PRESENT INVENTION

A semi-disposable face mask has a shaped molded base composed of silicone and/or TPE and molded forming a face seal, a filter media and a support structure that houses the shaped molded base and filter media in fluid communication allowing airflow from an environment through the filter media to the face seal.

### BRIEF DESCRIPTION OF THE DRAWINGS

The accompanying drawings, which are incorporated herein and constitute part of this specification, illustrate exemplary embodiments of the invention, and together with the description above, serve to explain further features of the invention.

FIG. 1 illustrates a mask of the invention having a base, filter, framing member and support member;

FIG. 2 illustrates an expanded view of the mask shown in FIG. 1;

FIG. 3 illustrates a mask of the invention having a base, filter and support member;

FIG. 4 illustrates an expanded view of the mask shown in FIG. 3;

FIGS. 5-7 illustrate construction and use of a mask of the invention having a base/support structure and filter;

FIGS. 8-9 illustrate an embodiment of the invention;

FIGS. 10-13 illustrate improvements in replaceable and washable filter media;

FIGS. 14-16 illustrate improvements in adaptive fit;

FIGS. 17-20 illustrate various improvements of the invention;

FIGS. 21-24 illustrate improvements in the composition of the invention; and,

FIGS. 25-29 illustrate PAPR adaptations combined with the invention.

### DETAILED DESCRIPTION OF THE PREFERRED EMBODIMENT

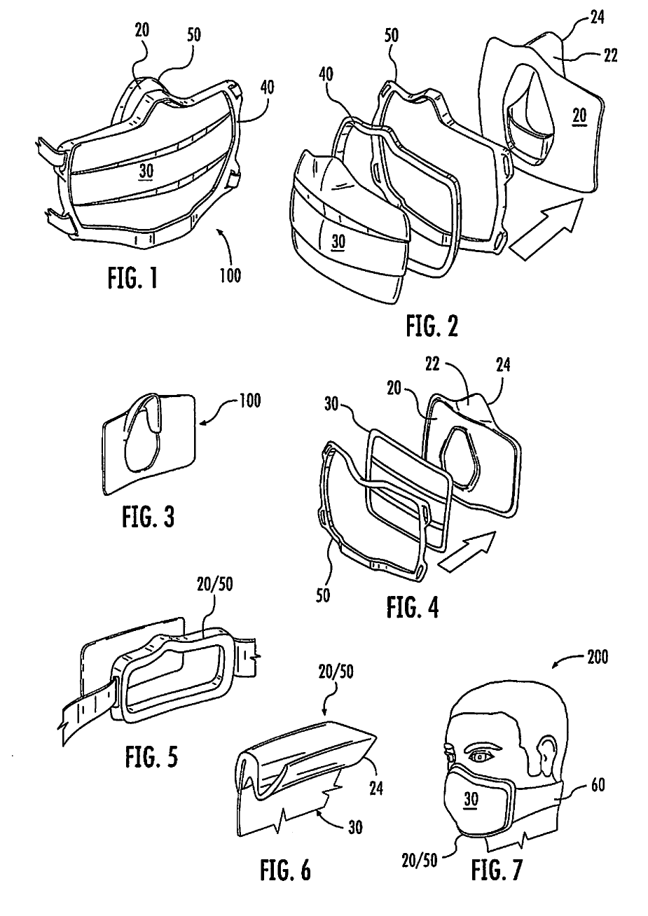

The invention includes improvements in mask wear and decontamination. Referring to FIGS. 1 and 2, a hybrid disposable mask 100 includes a shaped molded base 20 forming a face seal 22 with a sealing edge 24 for contact with the wearer's face. The shaped molded base 20, face seal 22 and sealing edge 24 preferably have a composition of silicone, thermoplastic elastomer (TPE) or combination thereof. Silicone and TPE materials include any appropriate silicone rubber or thermoplastic rubbers having thermoplastic and elastomeric properties appropriate for facial contact and filter support. The sealing edge 24 of the face seal 22 provides a comfortable fit and wear of the mask 100 to the wearer. Generally the molded sealing edge 24 includes a rounded and/or textured edge for a comfortable facial contact to increase the area of contact with the wearer's face for extended times of use, although various seal profile options may be used in the face seal 22 design. Representative examples of the face seal 22 include, without limitation, a flat seal, reverse reflex, standard reflex and other like configurations for facial comfort. The face seal 22 is preferably configured to allow a single size to fit most personnel using the device which is enhanced with the elastic composition of the silicone or TPE material allowing a very flexible arrangement and fitting. The face seal 22 provides an improved mass or physical wear features for long term use of the mask 100.

As additionally seen in FIGS. 1 and 2, a filter media 30 may be combined with the shaped molded base 20 in the hybrid disposable mask 100. The filter media 30 includes any appropriately constructed filter for a given use. Representative examples include, without limitation, pleated, sheet, molded, layered, or other planar formed filter media fixable within a framing structure. The filter media 30 may include the general form of a relatively flat or contoured face panels. Shapes include oval, rectangular, curved, pentagonal, etc. with the shape matching a framing structure and the shaped molded base 20 effectively to ensure an airtight seal of the mask 100. Typically, a pleated filter may provide a feel and texture similar to a fabric and allows the body of the face mask to expand outwardly and generally conform to the wearer's face so as to loosely cover the nose and mouth of a wearer. Filters 30 may be single, layered, or preferably comprise a sandwich of several layers, such as an outer facing layer, an intermediate filter media layer, and an inner facing layer. The filter media 30 may include an inner and outer layer with a binder material to impart stiffness to the sheet during use. The filter media 30 may include a replaceable filter media or washable filter media. In one preferred embodiment, the filter media 30 includes a high efficiency filtering media typically used in the medical or research field.

The filter media 30 is positioned within and a framing member 40 to maximize the filter media 30 area and to ensure optimum efficiency of the filter during use. This framing member 40 is attachable/detachable to a support structure 50 when in use. The framing member 40 preferably matches the perimeter of the filter media 30 and the support structure 50, allowing for the filter media 30 to remain as expanded as possible. The framing member 40 may be attached to the support structure through any appropriate locking mechanism, such as without limitation, latches, fictional contact, overhangs, pivot surfaces, twist insertions and the like, with fictional contact preferred. The framing member 40 provides a rigid structure to retain the filter media 30 in a given shape while allowing attachment to the support structure 50 without significant distortions of the shape.

The shaped molded base 20 attaches to the support structure 50, to maximize the area of the shaped molded base 20 and comfort of the user. The perimeter of the support structure 50 is generally similar to the perimeter of the shaped molded base 20, and the framing member 40 containing the filter media 30.

In operation, the assembled mask 100 is used within a work environment. After use the mask 100 is disassembled by detaching the framing member 40 (holding the filter media 30) from the support structure 50. The filter media 30 is removed from the framing member 40 and decontaminated or disposed of, as appropriate. The shaped molded base 20 is removed from the support structure 50, allowing both the shaped molded base 20 and support structure 50 to be thoroughly decontaminated. Additionally, the framing member 40, without the filter media 30 present, is decontaminated. Once decontaminated, the shaped molded base 20, framing member 40 and support structure 50 are reassembled into the mask 100 with either the decontaminated filter media 30 or new filter media 30. As such the invention provides a reuse and repeated disinfection durability, low breathing resistance as it includes a large area filter, improved protection and respirator fit.

In an alternative embodiment, shown in FIGS. 3 and 4, the invention includes the shaped molded base 20 attached to the support structure 50 with the filter media 30 therebetween. The filter media 30 is combined to the user's side of the support structure 50, and the shaped molded base 20 is then applied. In operation, the assembled mask 100 is used within a work environment. After use the mask 100 is disassembled by detaching the support structure 50 (holding the filter media 30) from the shaped molded base 20. The filter media 30 is removed from the support structure 50 and decontaminated or disposed of, as appropriate. The shaped molded base 20, being removed from the support structure 50, allows both the shaped molded base 20 and support structure 50 to be thoroughly decontaminated. Once decontaminated, the shaped molded base 20 and support structure 50 are reassembled into the mask 100 with either the decontaminated filter media 30 or new filter media 30.

In an alternative embodiment, shown in FIGS. 5-7, the invention includes the shaped molded base 20 forming the support structure 50 with the filter media 30 inserted into a ridge 66 in the shaped molded base 20/support structure 50 as seen in FIG. 6. The filter media 30, once inserted, is held in place over the user's 200 nose and mouth with a strap 60, shown in FIG. 7. In operation, the assembled mask 100 is used within a work environment. After use the mask 100 is disassembled by detaching the filter media 30 from the shaped molded base 20/support structure 50. Removed filter media 30 is decontaminated or disposed of, as appropriate. The shaped molded base 20/support structure 50 is thoroughly decontaminated. Once decontaminated, the shaped molded base 20/support structure 50 is reassembled into the mask 100 with the insertion of either the decontaminated filter media 30 or new filter media 30.

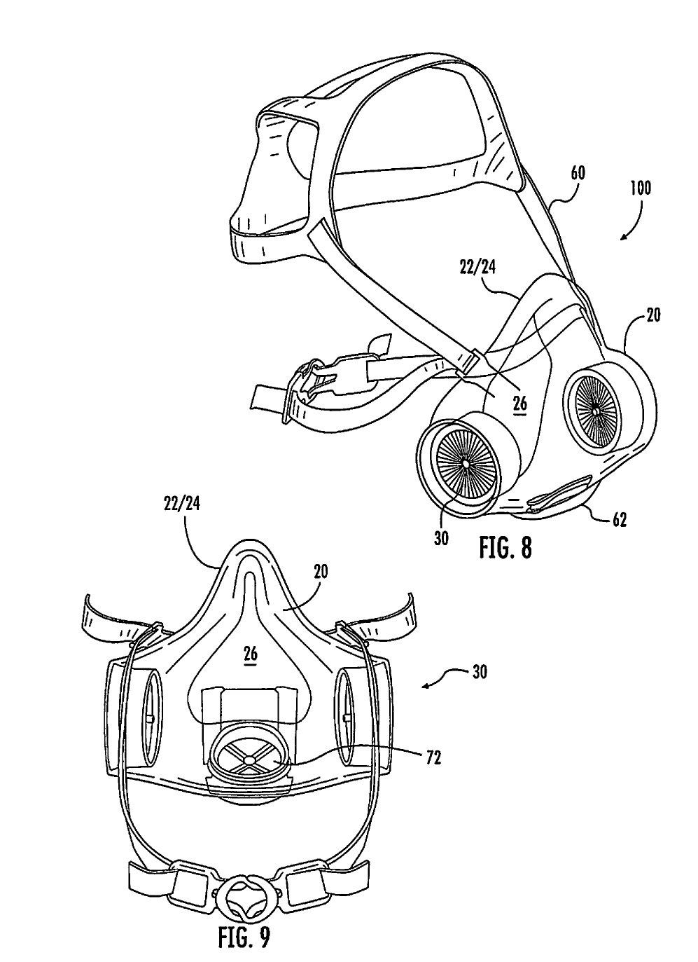

In the embodiment of the invention shown in FIGS. 8 and 9, the mask 100 includes filter media 30 that is preferably a replaceable and washable synthetic media having low breathing resistance filter pleating and media. The mask 100 includes an easy check and negative fit checking with hands as known by those skilled in the respirator arts. Additionally, a flexible and one size fits all head cradle 60 is readily cleaned, along with co-molded seal materials, smooth profile translucent oronasal 26. The mask 100 includes a downward facing exhale valve 72 and light weight assembly. In operation, the assembled mask 100 is used within a work environment. After use the mask 100 is disassembled by detaching the filter media 30) from the shaped molded base 20. The filter media 30 is removed and decontaminated or disposed of, as appropriate. The shaped molded base 20 is thoroughly decontaminated. Once decontaminated, the shaped molded base 20 is reassembled into the mask 100 with either the decontaminated filter media 30 or new filter media 30. As such the invention provides the mask 100 with easy disinfection, reuse and repeated disinfection durability, while additionally having a smooth external profile, improved breathing resistance, improved gauging fit, improved visual field, improved facial pressure using co-molded seal materials, improved air exchange having downward facing exhalation, improved mass or physical wear features, and improved facial visualization.

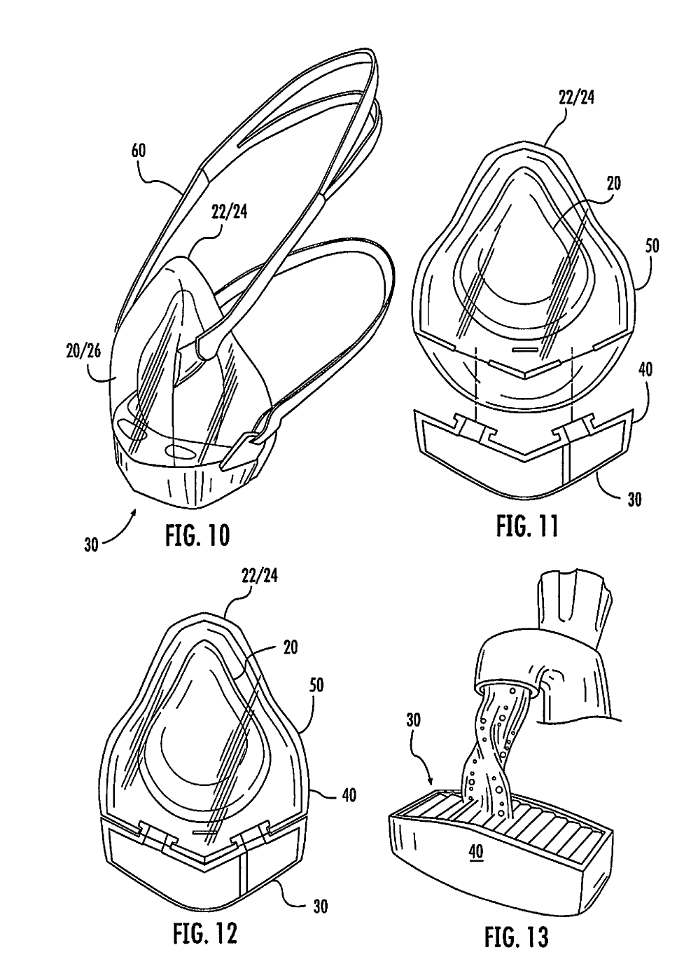

As seen in FIGS. 10-13, the invention includes the mask 100 with improved transmission reduction having single co-molded inhalation/exhalation filter 30. Referring to FIGS. 10-12, the mask 100 includes replaceable and washable filter media 30 (with decontamination filter media 30 shown in FIG. 13), that has a low breathing resistance filter media 30 installed into a low profile clear 26 silicone and/or TPE oronasal mask 100. The shaped molded base 20 is permanently fixed within a support structure 50, and the filter media 30 is placed, either permanently or temporarily, within the framing member 40.

In operation, the assembled mask 100 shown in to FIGS. 10-12 is used within a work environment. After use the mask 100 is disassembled by detaching the framing member 40 (holding the filter media 30) from the support structure 50. The filter media 30 may be removed from the framing member 40 if appropriate, or left intact within the framing member 40, and decontaminated or disposed of, as appropriate. The shaped molded base 20 and support structure 50 are thoroughly decontaminated. Additionally, the framing member 40, when the filter media 30 is removable, is decontaminated (shown in FIG. 13). When the filter media 30 is not removable from the framing member 40, it may be discarded for decontaminated when appropriate. Once decontaminated, the shaped molded base 20 and support structure 50 are reassembled into the mask 100 with either the decontaminated framing member 40 and filter media 30 or the decontaminated framing member 40 and new filter media 30. As such the mask 100 includes reuse and repeated disinfection durability, and improvements in breathing resistance, fomite transmission with the use of filtered exhalation, gauging fit, visual field and facial visualization.

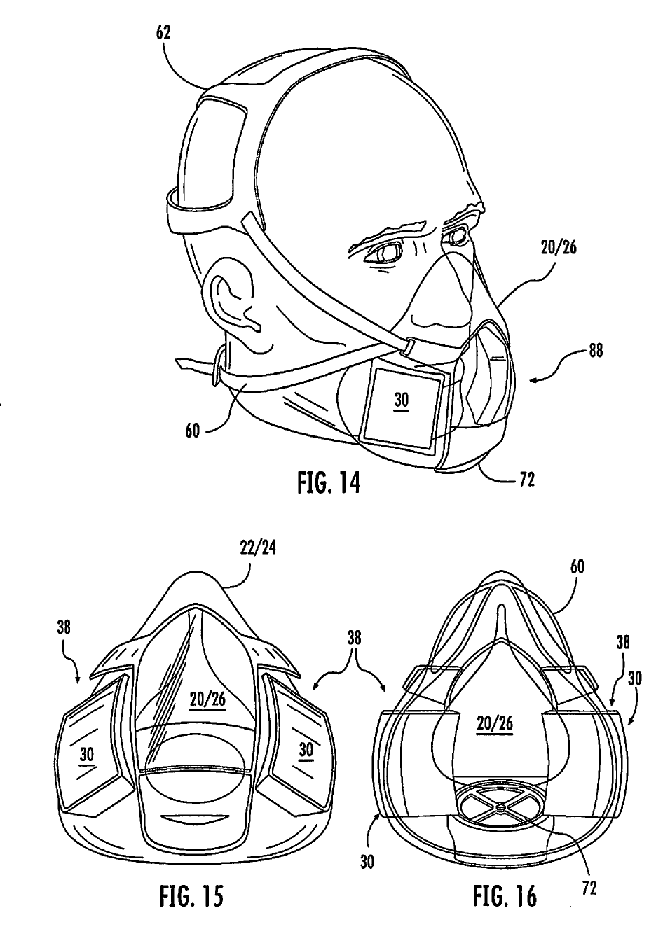

As seen in FIGS. 14-16, the invention includes the mask 100 with improvements in adaptive fit having flexible and one size fits all head cradle 62 that is easily cleaned. The mask 100 includes a smooth profile oronasal with a shaped molded base 20 having a clear 28 front for good user recognition. The mask 100 has a downward facing exhale valve 72 and an easy check and negative fit checking with hands. Filter media 30 of the mask 100 is replaceable and washable. The mask 100 provides a light weight assembly. Flap valves 38 direct air over clear section for potential de-misting and in-mold wire for face formability. The mask 100 provides reuse and repeated disinfection durability and improvements in speech intelligibility, breathing resistance, visual field, protection and respirator fit or adaptive fit, and facial visualization.

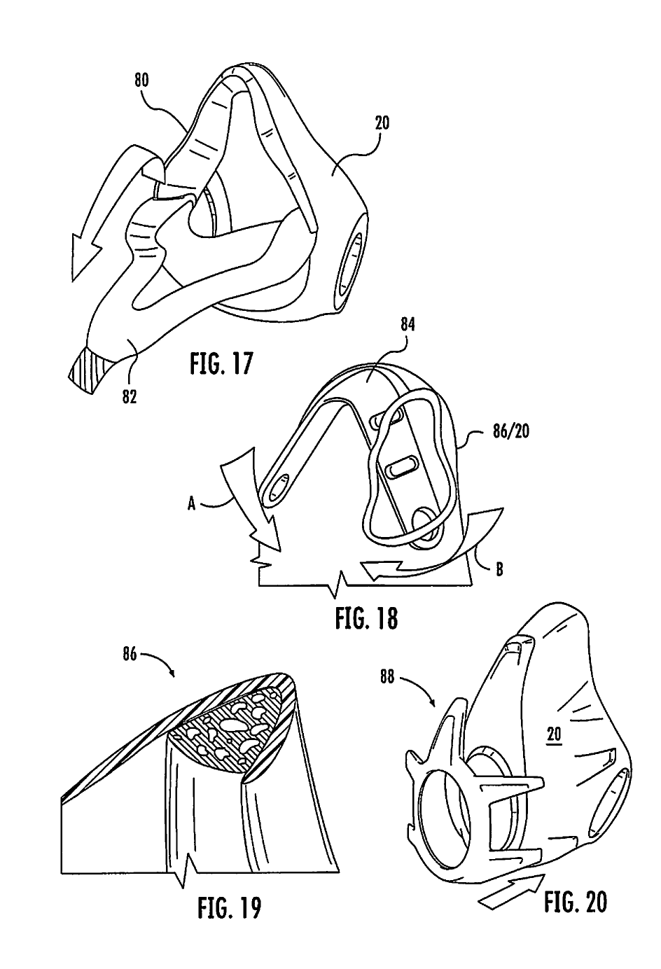

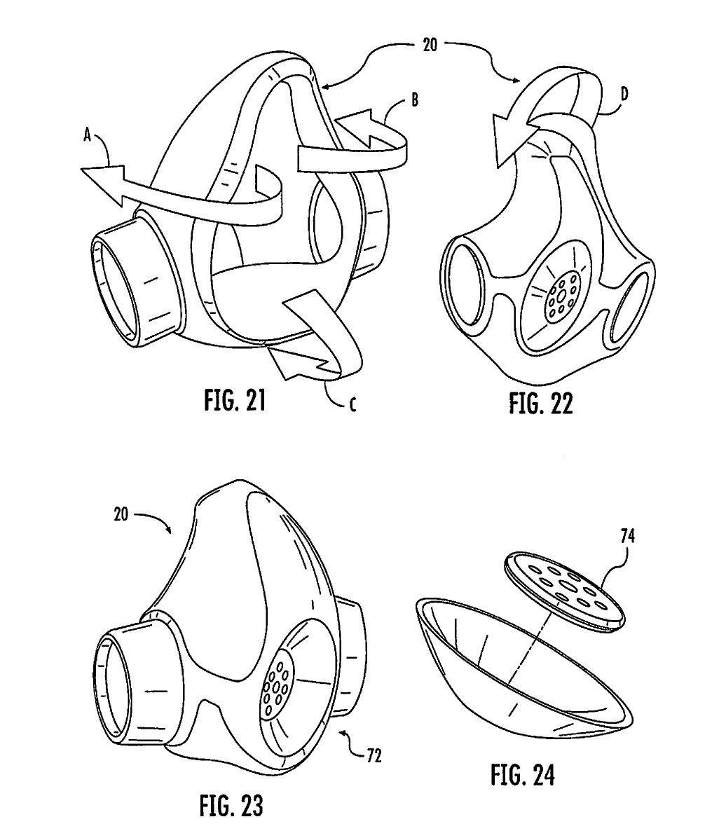

As seen in FIG. 17, the mask 100 includes improvements in fit accommodation and comfort having self adhesive seal 80 for difficult face forms. A protective sheet 82 may be peeled away from the adhesive seal 80 for application. Referring to FIG. 18, the mask 100 includes improvements in formable nasal strip for difficult nasal bridge issues. A collapsible support 84 within a nose section of the shaped molded base 20 is tightened with movement as shown in A-B, or expanded in the opposite direction of A-B. Referring to FIG. 19, the mask 100 includes improvements in gel based inserts 86 for seals and an additional formable part that allows user level fit issues and improved comfort and stability. Referring to FIG. 20, the mask 100 includes improvements in prolonged tolerability and improvements in facial pressure, and protection and respirator fit with the movement of an exoskeleton component 88 for fixing the placement of the shaped molded base 20. Additionally, as seen in FIGS. 21-24, longitudinal and lateral flexibility of the shaped molded base 20 is shown with arrows A-B-C-D (shown in FIGS. 21 and 22). Additionally, placement of the exhaust valve 72 and cover 74 with regard to the flexible shaped molded base 20 (shown in FIGS. 23 and 24).

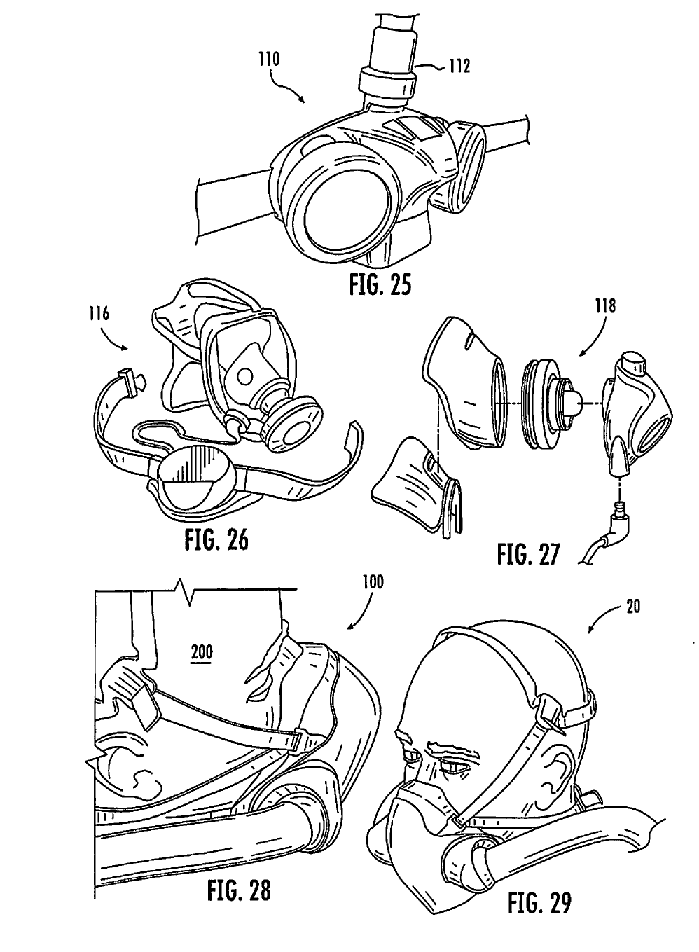

As seen in FIGS. 25-29, the invention includes the mask 100 which may combine with PAPR 110 applications having lower physiological burdens, e.g., cooling effect of blower or the work of breathing with supplied air 112 (shown in FIG. 25). Higher simulated workplace protection factor, such as an assigned Protection Factor (APF) of greater than 1000, swept back supply hose integration with lightweight and low profile for integration into health care worker personal protective ensembles 116 (shown in FIG. 26), respirator facial pressure low, directed exhalation path incorporated into supply system to capture/direct from patient, single battery charge per shift, and smooth supply hose surface for disinfection between uses, rotates on ball joint 118 (shown in FIG. 27) to move with wearer 200 (shown in FIG. 28-29). The mask 100 provides improvements in comfort and prolonged tolerability, breathing resistance, visual field, and gauging fit.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A semi-disposable face mask, comprising:
a shaped molded base, the base having a composition selected from the group consisting of silicone, TPE and combinations thereof, the shaped molded base forming a face seal;
a filter media; and,
a support structure, the support structure housing the shaped molded base and filter media in fluid communication allowing airflow from an environment through the filter media to the face seal.

2. The semi-disposable face mask of claim 1, further comprising a framing member for supporting the filter media.

3. The semi-disposable face mask of claim 1, wherein the base has a composition of silicone.

4. The semi-disposable face mask of claim 1, wherein the base has a composition of TPE.

5. The semi-disposable face mask of claim 1, wherein the face seal is a facial contact area selected from the group consisting of flat seal, reverse reflex seal, and standard reflex seal.

6. The semi-disposable face mask of claim 1, wherein the filter media is a high efficiency filtering media.

7. The semi-disposable face mask of claim 1, wherein the framing member fictionally locks into the support structure.

8. The semi-disposable face mask of claim 1, wherein the shaped molded base forms a ridge for insertion of the filter media.

9. The semi-disposable face mask of claim 1, further comprising an exhalation valve.

10. The semi-disposable face mask of claim 9, wherein the exhalation valve is downward facing.

11. The semi-disposable face mask of claim 2, wherein the filter media is permanently fixed within the framing member.

12. The semi-disposable face mask of claim 2, wherein the filter media is removably fixed within the framing member.

13. The semi-disposable face mask of claim 1, further including a head cradle.

14. The semi-disposable face mask of claim 1, wherein the face seal includes an adhesive seal.

15. The semi-disposable face mask of claim 1, wherein the shaped molded base includes a formable nasal strip

16. The semi-disposable face mask of claim 1, further comprising a PAPR.

17. A method for decontaminating a mask, comprising the steps of:
providing a semi-disposable face mask having a shaped molded base, the base having a composition selected from the group consisting of silicone, TPE and combinations thereof, the shaped molded base forming a face seal, a filter media and a support structure, the support structure housing the shaped molded base and filter media in fluid communication allowing airflow from an environment through the filter media to the face seal;
disassembling the mask to separate the filter media from the support structure and shaped molded base;
decontaminating the support structure and shaped molded base;
providing a decontaminated filter media selected from the group consisting of decontaminating the disassembled filter media and unused filter media; and,
assembling the support structure, shaped molded base and decontaminated filter media into a mask.

18. The method of claim 17, wherein the provided decontaminated filter media is the decontaminated disassembled filter media.

19. The method of claim 17, wherein the provided decontaminated filter media is unused filter media.

20. The method of claim 17, further comprising of providing a semi-disposable mask having a framing member, the filter media within the framing member, and the steps of disassembling the mask to separate the filter media contained within the framing member from the support structure and shaped molded base, separating the filter media from the framing member, decontaminating the framing member, assembling the decontaminated filter media within the decontaminated framing member, and assembling the decontaminated filter media within the decontaminated framing member into a mask with the support structure and shaped molded base.
